(19) United States
(12) Patent Application Publication
(10) Pub. No.: US 2007/0125611 A1
(43) Pub. Date: Jun. 7, 2007

(54) Shock absorber assembly with integrated jounce stop

(76) Inventors: Namir J. Zara, Sterling Heights, MI (US); Alan H. MacDonald, Novi, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/291,501

(22) Filed: Dec. 1, 2005

(51) Int. Cl. F16F 9/38

(52) U.S. Cl. 188/322.12; 188/297

(57) ABSTRACT

An integrated shock absorber assembly which integrates a shock absorber with a jounce stop and a coil spring. At an upper end of the cylinder of the shock absorber is a bumper cap in the form a robust annular washer. A jounce stop includes a bump cushion, a cushion cup having dimpling to provide a cup abutment, and a jounce stop bracket for attachment to the motor vehicle frame. As maximum jounce is approached, the bumper cap resiliently compresses the bump cushion, and in a maximum jounce, the bumper cap strikes, metal-to-metal, the cup abutment.

### TECHNICAL FIELD

The present invention relates to automotive suspension systems, particularly the shock absorbers, coil springs and jounce stops thereof, wherein the jounce stop includes a bump cushion and metal-to-metal stop. More particularly, the present invention relates to a shock absorber assembly which integrates a shock absorber with a jounce stop, and preferably, also integrates therewith a coil spring.

### BACKGROUND OF THE INVENTION

Motor vehicle suspension systems are configured so that the wheels are able to follow elevational changes in the road surface as the vehicle travels therealong. When a rise in the road surface is encountered, the suspension responds in “jounce” in which the wheel is able to move upwardly relative to the frame of the vehicle. On the other hand, when a dip in the road surface is encountered, the suspension responds in “rebound” in which the wheel is able to move downwardly relative to the frame of the vehicle. In either jounce or rebound, a spring (i.e., coil, leaf, torsion, etc.) is incorporated at the wheel in order to provide a resilient response to the respective vertical movements with regard to the vehicle frame. However, in order to prevent wheel bouncing and excessive vehicle body motion, a shock absorber is placed at the wheel to dampen wheel bounce. Additionally, a bump cushion is provided which resiliently compresses at an extreme jounce event, in order to absorb energy and provide a rapidly increasing reaction force to the force of the jounce. In order for the suspension to handle a maximum jounce event, a situation in which the bump cushion is compressed to its limit, a designated metal-to-metal stop is provided to stop the jounce event.

Referring now to FIG. 1, components of a conventional suspension system 10 are depicted which allow for jounce and rebound at a wheel of the subject motor vehicle.

A control arm 12 is pivotally mounted with respect to the motor vehicle frame 14, wherein, in the depicted example, a torsion spring 16 is utilized (a coil or leaf spring could also be utilized) to provide resilient response for the jounce and rebound of the control arm relative to the frame. To dampen jounce and rebound bounce, a shock absorber 18 is connected pivotally at one end to the frame 14 and connected pivotally at the other end to the control arm 12. To provide cushioning in the event a maximum jounce is approached, a bump cushion 20 which is mounted to the frame 14 via a dimpled cushion cup 22, wherein the dimples 24 thereof serve to hold the bump cushion therein. The bump cushion 20 is resiliently compressed by movement of the control arm as jounce approaches its maximum. At maximum jounce, a surface 26 of the control arm 12 will metal-to-metal impact an outer annular flange 28 of the cushion cup 22.

The shock absorber 18 has an internally disposed valved piston which is reciprocably movable within a shock cylinder 30. A shock rod 32 is attached to the valved piston and is guided by a shock rod guide at one end of the shock cylinder. The instantaneous position of the valved piston within the shock cylinder 30 defines a first interior portion and a second interior portion of the interior of the shock cylinder. In operation, as the control arm undergoes jounce or rebound, oil is displaced between the first and second interior portions, causing hydraulic pressure on the valved piston, whereby oil metering through the valved piston provides jounce or rebound damping.

The bump cushion 20 has an optional skin of a pliant plastic material and an interior of resilient elastomeric material, which may be for example a rubber, rubber-like material, or micro-cellular urethane. In operation as the control arm approaches maximum jounce, the bump cushion compresses, delivering a reaction force on the control arm which increases with increasing compression so as to minimize the severity of impact of the control arm with respect to the frame as a maximum jounce is approached. In a maximum jounce event, a metal-to-metal impact occurs by the surface 26 impacting the flange 28. Immediately following the jounce, the rebound involves the energy absorbed by the compression of the bump cushion being delivered resiliently back to the suspension.

What remains needed in the art is an improved motor vehicle suspension system in which a shock absorber is integrated with a jounce stop, inclusive of the bump stop and metal-to-metal stop, as well as preferably inclusive of a coil spring.

### SUMMARY OF THE INVENTION

The present invention is an integrated shock absorber assembly which integrates a shock absorber with a jounce stop (inclusive of a bump cushion and metal-to-metal stop); and preferably also integrates a coil spring, to thereby collectively provide an improved motor vehicle suspension system.

The shock absorber of the integrated shock absorber assembly according to the present invention has a cylinder and shock rod which cooperate to provide jounce and rebound damping in the manner described hereinabove. At an upper end of the cylinder is a bumper cap in the form a robust annular washer.

A jounce stop includes a bump cushion, a cushion cup and a jounce stop bracket. The bump cushion is composed of a resiliently flexible material as generally described hereinabove; however, now the bump cushion has a central bore. The cushion cup has a cup bottom and an annular cup sidewall, wherein the cup bottom has a central hole. Dimpling (an annular dimple or a plurality of discrete dimples) of the cup sidewall provide a cup abutment within the cushion cup generally proximal to the cup bottom. The bump cushion is placed into the cushion cup wherein the central bore is aligned with the central hole. The jounce stop bracket is configured to connect the cushion cup and an end of the shock rod to the motor vehicle frame.

A coil spring is preferably integrated with the shock absorber assembly, being sandwiched between an annular cylinder spring seat connected with the cylinder at a generally medial location thereof, and an annular bracket spring seat adjacent the jounce stop bracket.

A generally cylindrically shaped jounce stop shield is preferably connected with the jounce stop bracket for providing environmental protection for the bump cushion and the cushion cup.

In operation of the integrated shock absorber assembly according to the present invention, a normal range jounce and rebound are handled by the shock absorber and the coil spring. However, at an extreme of jounce, wherein the control arm has a large amount of movement, the bumper cap compresses the bump cushion, whereby energy of the jounce is absorbed and an opposite force applied by the bump cushion acting against the jounce force. In the event a maximum jounce event occurs, wherein the bump cushion is compressed to its limit, the bumper cap will strike the cup abutment of the dimpling, thereby providing a positive metal-to-metal stop. When rebound occurs, the bump cushion will resiliently resume its normal shape.

Accordingly, it is an object of the present invention to provide an integrated shock absorber assembly which integrates a shock absorber with a jounce stop (inclusive of a bump cushion and metal-to-metal stop), and preferably also integrating a coil spring, to collectively provide an improved motor vehicle suspension system.

This and additional objects, features and advantages of the present invention will become clearer from the following specification of a preferred embodiment.

### BRIEF DESCRIPTION OF THE DRAWINGS

FIG. 1 is a perspective view of a conventional suspension system, including a control arm, a frame, a spring, a conventional shock absorber, a conventional bump cushion, and conventional cushion cup.

FIG. 2 is a is a perspective view of a suspension system, including a control arm and a frame, as well as an integrated shock absorber assembly according to the present invention.

FIG. 3 is a partly sectional side view of the integrated shock absorber assembly according to the present invention.

FIG. 4 is a top plan view, seen along line 4-4 of FIG. 3.

FIG. 5 is a detail, broken-away side view, seen along line 5 of FIG. 3.

FIG. 6 is a bottom plan view, seen along line 6-6 of FIG. 3.

FIG. 7 is a detail, broken away side view, seen along arrow 7 of FIG. 3.

FIG. 8 is a sectional view of a jounce stop according to the present invention.

FIG. 8A is a partly sectional view, seen along line 8A-8A of FIG. 8.

FIG. 9 is partly sectional side view similar to that of FIG. 3, wherein now an operational jounce has resulted in compression of the bump cushion of the jounce stop according to the present invention.

FIG. 9A is partly sectional, detail side view of the jounce stop according to the present invention, wherein the metal-to-metal stop is operating at a maximum jounce situation of operation.

### DESCRIPTION OF THE PREFERRED EMBODIMENT

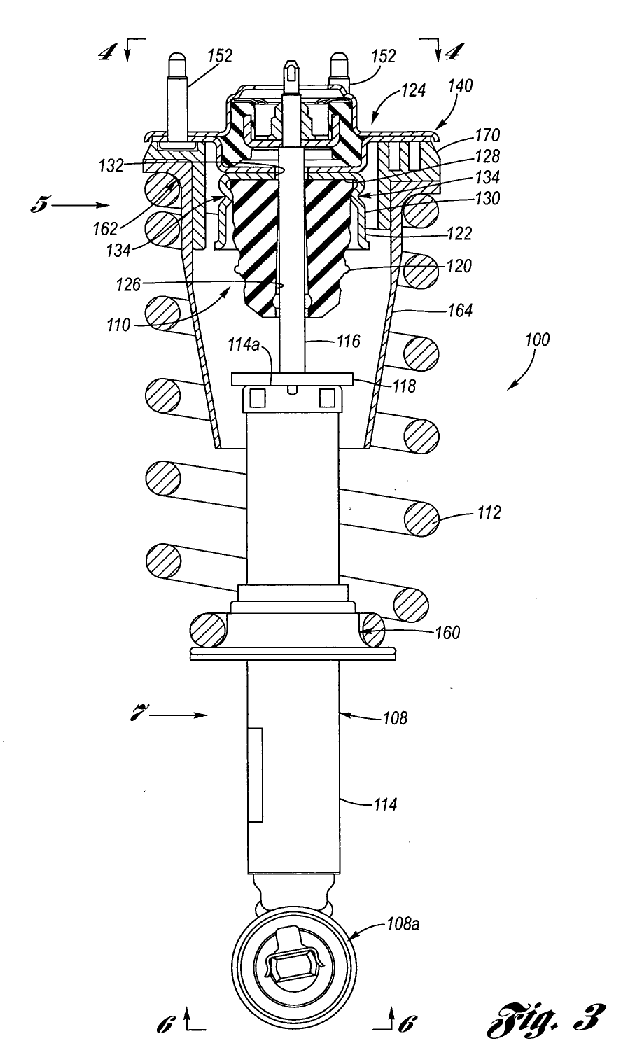

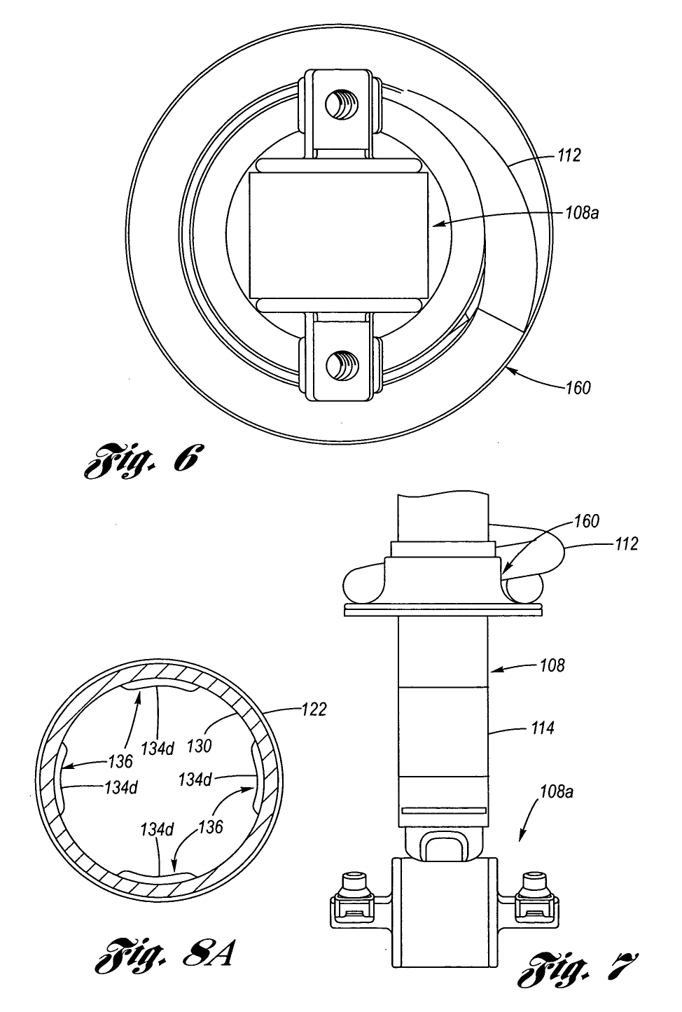

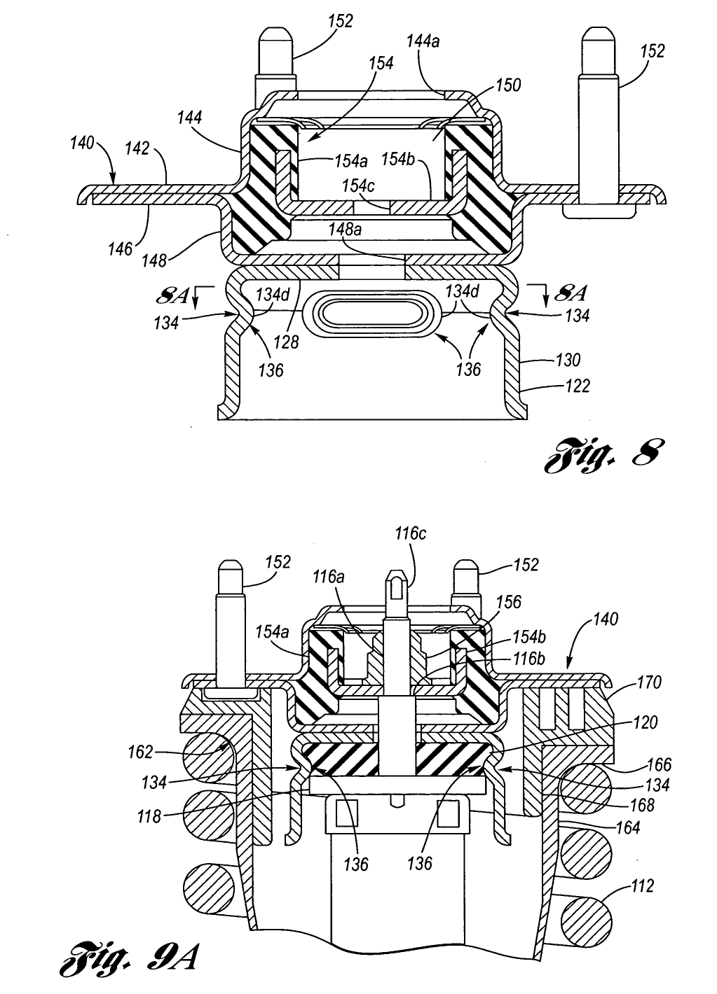

Referring now to the Drawing, FIGS. 2 through 9A depict various aspects of an integrated shock absorber assembly 100 according to the present invention.

Referring firstly to FIG. 2, components of an improved suspension system 102 including the integrated shock absorber assembly 100 according to the present invention are depicted which allow for control of jounce and rebound at a wheel of the subject motor vehicle. A control arm 104 is pivotally mounted with respect to the motor vehicle frame 106 to provide pivoting response to jounce and rebound of the control arm relative to the frame. To provide control over jounce and rebound, the integrated shock absorber assembly 100 connects to the frame 106 and pivotally connects to the control arm 104.

Referring now additionally to FIGS. 3 through 8 the structure and function of the integrated shock absorber assembly 100 will be detailed.

The integrated shock absorber assembly 100 integrates a shock absorber 108 with a jounce stop 110, inclusive of a bump cushion and metal-to-metal stop, and in the preferred embodiment also integrates a coil spring 112, to thereby collectively provide the improved motor vehicle suspension system 102.

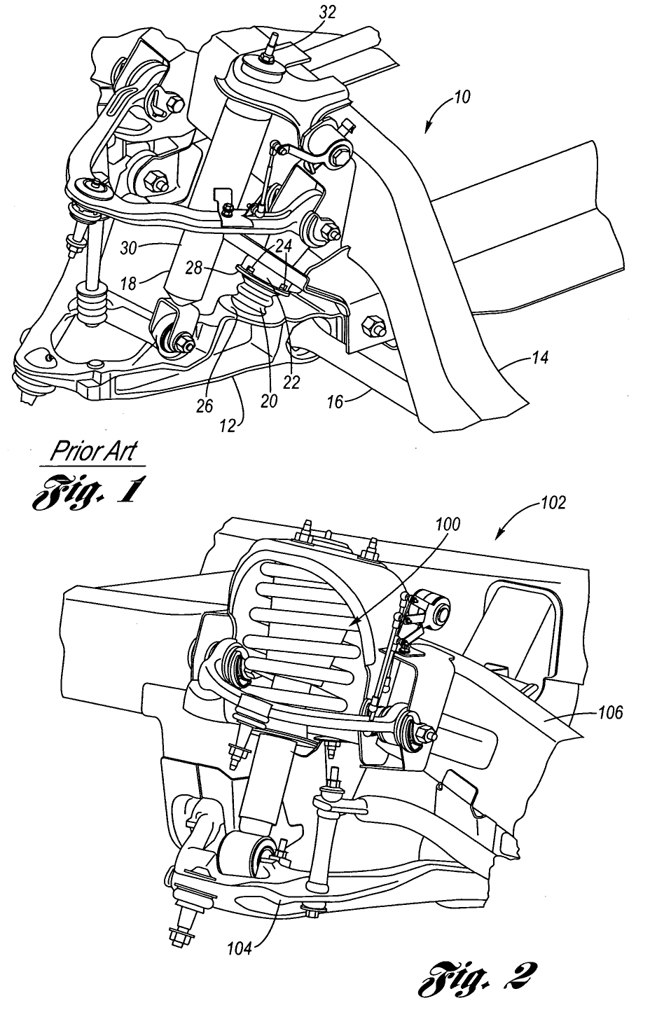

The shock absorber 108 of the integrated shock absorber assembly 100 has a cylinder 114 and shock rod 116 which cooperate to provide jounce and rebound bounce damping generally in the manner described hereinabove with respect to the shock absorber 18 of FIG. 1. At an upper end 114a of the cylinder 114 is attached, as by welding, a bumper cap 118 in the form a robust annular washer. The lower end of the shock absorber 108 includes a pivot member 108a for providing the above mentioned pivotal connection to the control arm 104.

The jounce stop 110 includes a bump cushion 120, a cushion cup 122 and a jounce stop bracket 124.

The bump cushion 120 is composed of a resiliently flexible material having an optional skin as generally described hereinabove with respect to the bump cushion 20 of FIG. 1; however, now the bump cushion has a central bore 126 through which the shock rod 116 passes. The bump cushion 120 has a generally cone shape having fluting or other contouring to facilitate its resilient compression during extreme jounce events.

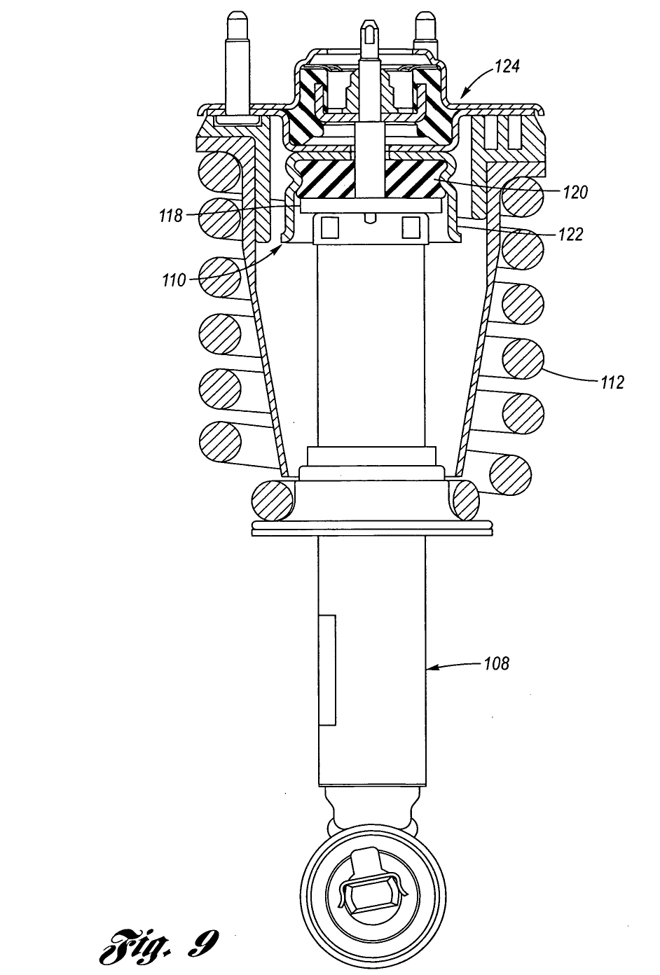

The cushion cup 122 has a cup bottom 128 and an integrally connected annular cup sidewall 130. The cup bottom 128 has a central hole 132 through which the shock rod 116 passes. Dimpling 134 (an annular dimple or a plurality of discrete dimples, four dimples 134d being preferred) of the cup sidewall 130 provide a cup abutment 136 (see FIGS. 8 and 8A) within the cushion cup proximal to the cup bottom 128. The bump cushion 120 is receivably seated in the cushion cup 122, whereby the bump cushion abuts the cup bottom 128, and wherein the central bore 126 is aligned with the central hole 132.

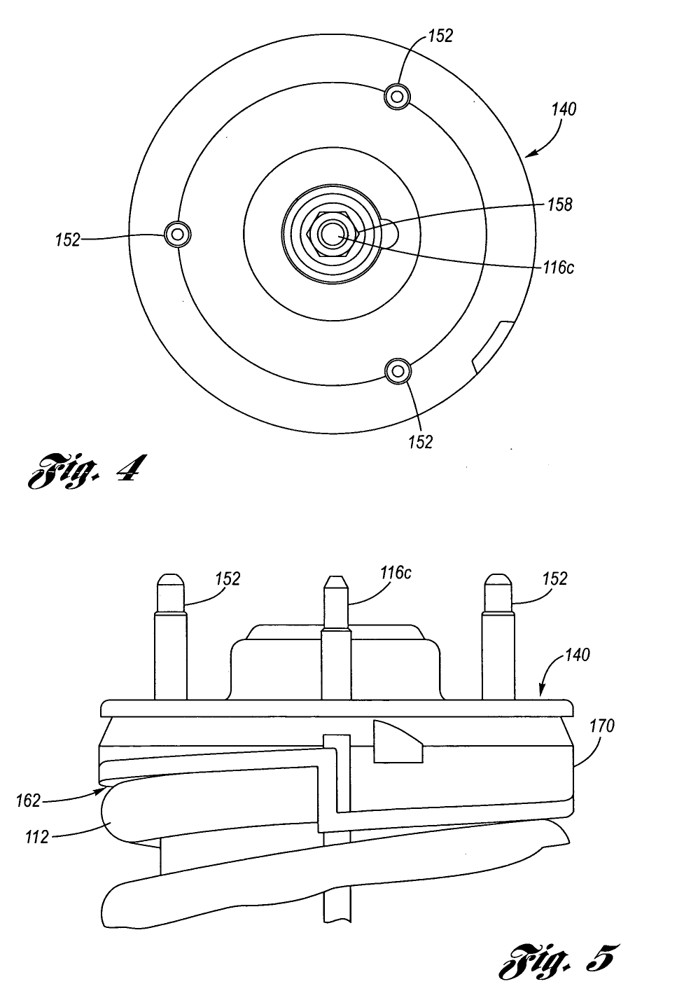

The jounce stop bracket 124 connects the cushion cup 122 and an end 116c of the shock rod 116 to the motor vehicle frame. As shown best at FIG. 8, a mounting flange 140 is a composite of a first disk 142 having a first hub 144 and a second disk 146 having a second hub 148, wherein the second hub has a hub hole 148a for receiving therethrough the shock shaft 116. The first and second hubs being arranged in mutual opposition so as to mutually provide an interior space 150. The mounting flange carries a plurality of mounting bolts 152, preferably three in number, for mounting to the motor vehicle frame utilizing suitable nuts for threading thereonto. Within the interior space 150 is located a shock shaft carriage 154, preferably in the form of an annular resilient grommet 154a and a centrally disposed shock shaft collar 154b. In this regard, seen best collectively at FIGS. 4 and 9A, a reduced diameter portion 116a of the shock shaft 116 provides an abutment 116b at a collar hole 154c of the shock shaft collar 154b, wherein the shock shaft is trapped on the shock shaft collar via a collet 156 and a nut 158 threaded onto the end 116c of the shock shaft via an opening 144a in the first hub 144.

The coil spring 112 is integrated with the shock absorber assembly 100 by being sandwiched between an annular cylinder spring seat 160 connected with the cylinder 114 at a generally medial location thereof, and an annular bracket spring seat 162 adjacent the jounce stop bracket 124.

A generally cylindrically shaped jounce stop shield 164 is connected with the jounce stop bracket 124 for providing environmental protection for the bump cushion 120, the cushion cup 122, the shock shaft 116 and the bumper cap 118. In a preferred arrangement shown best at FIG. 9A, the jounce stop shield 164 has a lip 166 which, in combination with a shield sidewall 168, serve as the bracket spring seat 162, whereby the jounce stop shield is located with respect to the mounting flange 140 via a mounting drum 170.

In operation of the integrated shock absorber assembly 100, a normal range jounce and rebound are handled by the shock absorber 108 and the coil spring 112. However, at an extreme of jounce as shown at FIG. 9 wherein the control arm 104 has a large amount of movement, the bumper cap 118 compresses the bump cushion 120, whereby energy of the jounce is absorbed and an opposite force applied by the bump cushion acting against the jounce force. In the event a maximum jounce event occurs as shown at FIG. 9A wherein the bump cushion is compressed to its limit, the bumper cap 118 will strike the cup abutment 136 of the dimpling 134, thereby providing a positive metal-to-metal stop. When rebound occurs, the bump cushion will resiliently resume its normal shape.

To those skilled in the art to which this invention appertains, the above described preferred embodiment may be subject to change or modification. Such change or modification can be carried out without departing from the scope of the invention, which is intended to be limited only by the scope of the appended claims.

1. An integrated shock absorber assembly for a motor vehicle suspension, comprising:
a shock absorber comprising a cylinder and a shock shaft;
a bumper cap attached to an end of said cylinder; and
a jounce stop, said jounce stop comprising:
a cushion cup having a cup abutment;
a bump cushion located at said cushion cup; and
a jounce stop bracket, wherein an end of said shock shaft and said cushion cup are connected to said jounce stop bracket;
wherein said integrated shock absorber assembly is operable between a range of jounce and rebound of the motor vehicle suspension system, including a maximum jounce;
wherein as the maximum jounce is approached, said bumper cap resiliently compresses said cushion cup; and
wherein at the maximum jounce, said bumper cap strikes said cup abutment.

2. The assembly of claim 1, further comprising:
a coil spring;
a cylinder spring seat attached to said cylinder; and
a bracket spring seat located adjacent said jounce stop bracket;
wherein said coil spring is operably trapped between said cylinder and bracket spring seats.

3. The assembly of claim 1, further comprising a jounce stop shield located adjacent said jounce stop bracket, said jounce stop shield shieldably covering said bump cushion and said cushion cup.

4. The assembly of claim 1, wherein said jounce stop bracket comprises:
a mounting flange defining an interior space; and
a shock shaft carriage located in said interior space;
wherein said end of said shock shaft is connected with said shock shaft carriage.

5. The assembly of claim 1, wherein said cushion cup comprises:
a cup bottom; and
an annular cup sidewall adjoining said cup bottom;
wherein said cup abutment comprises dimpling of said cup sidewall.

6. The assembly of claim 2, wherein said cushion cup comprises:
a cup bottom; and
an annular cup sidewall adjoining said cup bottom;
wherein said cup abutment comprises dimpling of said cup sidewall.

7. The assembly of claim 6, wherein said jounce stop bracket comprises:
a mounting flange defining an interior space; and
a shock shaft carriage located in said interior space;
wherein said end of said shock shaft is connected with said shock shaft carriage.

8. The assembly of claim 7, further comprising a jounce stop shield located adjacent said jounce stop bracket, said jounce stop shield shieldably covering said jounce stop.

9. The assembly of claim 8, wherein said bracket spring seat comprises:
a lip of said jounce stop shield; and
a shield sidewall of said jounce stop shield, said lip adjoining said shield sidewall;
wherein said jounce stop shield is located adjacent said mounting bracket via a mounting drum.

10. The assembly of claim 9, wherein said shock shaft carriage comprises:
a resilient grommet; and
a shock shaft collar centrally mounted to said grommet;
wherein said end of said shock shaft is connected to said shock shaft collar.

11. An integrated shock absorber assembly for a motor vehicle suspension, comprising:
a shock absorber comprising a cylinder and a shock shaft;
a bumper cap attached to an end of said cylinder;
a jounce stop, said jounce stop comprising:
a cushion cup comprising a cup bottom;
an annular cup sidewall adjoining said cup bottom; and
dimpling of said sidewall, wherein said dimpling comprises a cup abutment;
a bump cushion located at said cushion cup; and
a jounce stop bracket, wherein an end of said shock shaft and said cushion cup are connected to said jounce stop bracket;
a coil spring;
a cylinder spring seat attached to said cylinder;
a bracket spring seat located adjacent said jounce stop bracket, wherein said coil spring is operably trapped between said cylinder and bracket spring seats; and
a jounce stop shield located adjacent said jounce stop bracket, said jounce stop shield shieldably covering said bump cushion and said cushion cup;
wherein said integrated shock absorber assembly is operable between a range of jounce and rebound of the motor vehicle suspension system, including a maximum jounce;
wherein as the maximum jounce is approached, said bumper cap resiliently compresses said cushion cup; and
wherein at the maximum jounce, said bumper cap strikes said cup abutment.

12. The assembly of claim 11, wherein said jounce stop bracket comprises:
a mounting flange defining an interior space; and
a shock shaft carriage located in said interior space;
wherein said end of said shock shaft is connected with said shock shaft carriage.

13. The assembly of claim 12, wherein said bracket spring seat comprises:
a lip of said jounce stop shield; and
a shield sidewall of said jounce stop shield, said lip adjoining said shield sidewall;
wherein said jounce stop shield is located adjacent said mounting bracket via a mounting drum.

14. The assembly of claim 13, wherein said shock shaft carriage comprises:
a resilient grommet; and
a shock shaft collar centrally mounted to said grommet;
wherein said end of said shock shaft is connected to said shock shaft collar.
